(19) United States
(12) Patent Application Publication
(10) Pub. No.: US 2013/0196306 A1
(43) Pub. Date: Aug. 1, 2013

(54) ON-LINE LEARNING SYSTEM AND METHOD

(71) Applicant: Jim Tetreau, Los Angeles, CA (US)

(72) Inventor: Jim Tetreau, Los Angeles, CA (US)

(21) Appl. No.: 13/757,707

(22) Filed: Feb. 1, 2013

Related U.S. Application Data
(60) Provisional application No. 61/593,786, filed on Feb. 1, 2012.

(51) Int. Cl. G09B 7/00

(52) U.S. Cl. CPC G09B 7/00
USPC 434/350

(57) ABSTRACT

A system and an automated method of on-line learning for a student over an electronic communications network are provided. The method includes: electronically receiving, over the network, control information related to the student from one or more parents, teachers, or sponsors of the student; electronically distributing, over the network, on-line problems from a content database arranged by levels of difficulty and by categories to an electronic learning device of the student based on the control information; electronically receiving, over the network, answers to the problems from the learning device; electronically grading the answers to the problems; and rewarding an electronic allowance to the student based on the grading of the answers and the control information. The system includes a processor coupled to the network, and a non-volatile storage device coupled to the processor and including a content database and program instructions for performing the method when executed on the processor.

### CROSS-REFERENCE TO RELATED APPLICATION(S)

This Patent Application claims the benefit of U.S. Provisional Patent Application Ser. No. 61/593,786, filed Feb. 1, 2012 and entitled “ON-LINE LEARNING SYSTEM AND METHOD,” (hereinafter, “the Provisional Application”) the entire content of which is hereby expressly incorporated by reference.

### FIELD

Aspects of embodiments of the present invention relate to a system and method of on-line learning.

### BACKGROUND

62% of parents give their children a weekly allowance. Allowances have traditionally been tied to performing household chores and mowing the lawn. The Internet has made available a number of new opportunities, such as on-line gaming, on-line shopping, on-line banking, etc. Motivating kids to academically perform up to their potential has been a struggle for many parents, teachers, and other interested parties.

### SUMMARY

Embodiments of the present invention provide for a system and method of on-line learning for a student that combines computer-learning technology with old-fashioned allowances in a contemporary setting to provide a powerful educational and motivational tool.

Embodiments of the present invention enable students to earn a monetary “academic allowance” immediately online by achieving performance goals set by their parent, teacher, or sponsor, then spend, save or bank it. Earning follows leaning by successfully running sprints, laps, and marathons and improving their vocabulary, word, and school subject proficiency.

Embodiments of the present invention create a market that currently does not exist. Though the Internet offers endless educational sites for students, our research has found no other site that gives students the option to earn a real-time monetary “academic allowance” provided in the traditional way by parents and tied to the student's performance.

Other embodiments of the present invention will enable parents and/or sponsors to define, track, and verify educational and graduation benchmarks for students prior to the student's ability to vest the “academic allowance” they have earned and saved.

Part of the larger goal is to provide an effective incentive for millions of low-income, drop-out-risk students to earn their “academic allowance” by soldiering though their own community and personal challenges to earn their high school diploma.

There was once a time when kids earned their allowance performing household chores and mowing the lawn—Embodiments of the present invention now offer an educational, motivational and contemporary option—an avenue for all kids to “Learn, Earn & Download” by achieving performance goals set by their parent, teacher, or sponsor.

Academic categories are listed under School Subjects. Here is a taste of some fun sprints with some FUNky ones, too.

Euphemisms, Oxymorons

Finish the Phrase, Rope the Metaphor and Nerb

Shares a Border With, States by Landmark

City by State or State by City

Weights & Measurements, Name the Element or Name the Science

Music; Finish the Lyric, Languages; Slang, Finish the Yiddish

Literature; Novels by Character, Authors by Novel & Famous First Lines

TV; Show by Expression or Product by Slogan

Movie by Character, Name the Movie (Famous movie lines), or Oscar Winners

History; Who Said It? And Who Am I: and . . . and so many more to come!

Understanding the game features and terms will best illuminate the expansive possibilities we detail in the overall plan and projections. Though we will introduce a steady stream of new vocabulary, word, and knowledge-driven games through embodiments of the present invention, we will also provide a platform for third party edugamers and freelancers.

Terms & Features detailed below are for a Word Clusters embodiment of the present invention.

Word Strings, being more data & subject intensive, is another embodiment of the present invention. Strings are more complex, subject-driven exercises than are Clusters and may be used by students repeatedly for optimum retention of subject material.

An example String is for The Declaration of Independence. Strings lead the learning of facts chronologically, one fact or concept following another so the subject material is learned organically and trained into the brain for optimal retention.

Think W(ord) is the working title of another adrenaline-producing embodiment of the present invention. In this embodiment, 2 clues are provided: the 1st letter of the correct answer along with a brief definition, such as:

| Think W | Think U... | Think H... |
|---|---|---|
| Lost husband by death | Mother or father's brother | Shockingly ugly |
| ↓ | ↓ | ↓ |
| Widow → | ? → | ? → |

. . . and the player types the answer into the field before the clock counts out—or in another embodiment, speaks the answer into a voice recognition feature to be incorporated (for example, coded) into the game.

Attempting to beat the clock by hurdling 30 of these clusters in a Sprint is truly rope jumping for the brain if you can imagine the adrenaline and sense of self-competition it produces.

In example games and categories according to the present invention, material id custom-written for each grade level.

Embodiments of the present invention are intended to be age-engaging and personalized.

In an exemplary embodiment of the present invention, an automated method of on-line learning for a student over an electronic communications network is provided. The method includes: electronically receiving, over the network, control information related to the student from one or more parents, teachers, or sponsors of the student; electronically distributing, over the network, on-line problems from a content database arranged by levels of difficulty and by categories to an electronic learning device of the student based on the control information; electronically receiving, over the network, answers to the problems from the learning device; electronically grading the answers to the problems; and rewarding an electronic allowance to the student based on the grading of the answers and the control information.

The control information may include one or more of one of the levels of difficulty, one of the categories, educational or graduation benchmarks, a rate of earning the allowance, or timing between the distributing of the on-line problems and the receiving of the answers to the problems.

The method may further include distributing, to the one or more parents, teachers, or sponsors, tracking or verification information of the student related to the educational or graduation benchmarks.

The method may further include receiving, from the one or more parents, teachers, or sponsors, electronic funds to fund the allowance.

The method may further include disbursing the electronic funds to the student based on the allowance and the control information.

The disbursing of the electronic funds may include one or more of on-line shopping at a retail enterprise, on-line savings to a savings account, or on-line donations to a charitable institution.

The method may further include electronically banking an unfunded portion of the allowance for later funding.

The learning device may include a computer, a laptop, a tablet, a personal digital assistant, or a smart phone.

The method may further include controlling a timing of the distributing of the on-line problems to and the receiving of the answers from the learning device.

The method may further include: electronically storing, for the student, an average of the problems answered per unit of time from the timing; and further controlling the timing according to the average.

In another exemplary embodiment of the present invention, a system of on-line learning for a student is provided. The system includes a processor coupled to an electronic communications network and a non-volatile storage device coupled to the processor. The nonvolatile storage device is for storing a content database including problems arranged by levels of difficulty and by categories, and program instructions. The program instructions, when executed by the processor, cause the processor to: receive, over the network, control information related to the student from one or more parents, teachers, or sponsors of the student; distribute, over the network, on-line problems from a content database arranged by levels of difficulty and by categories to an electronic learning device of the student based on the control information; receive, over the network, answers to the problems from the learning device; grade the answers to the problems; and reward an electronic allowance to the student based on the grading of the answers and the control information.

The control information may include one or more of one of the levels of difficulty, one of the categories, educational or graduation benchmarks, a rate of earning the allowance, or timing between the distributing of the on-line problems and the receiving of the answers to the problems.

The program instructions, when executed by the processor, may further cause the processor to distribute, to the one or more parents, teachers, or sponsors, tracking or verification information of the student related to the educational or graduation benchmarks.

The program instructions, when executed by the processor, may further cause the processor to receive, from the one or more parents, teachers, or sponsors, electronic funds to fund the allowance.

The program instructions, when executed by the processor, may further cause the processor to disburse the electronic funds to the student based on the allowance and the control information.

The disbursing of the electronic funds may include one or more of on-line shopping at a retail enterprise, on-line savings to a savings account, or on-line donations to a charitable institution.

The program instructions, when executed by the processor, may further cause the processor to bank an unfunded portion of the allowance for later funding.

The learning device may include a computer, a laptop, a tablet, a personal digital assistant, or a smart phone.

The program instructions, when executed by the processor, may further cause the processor to control a timing of the distributing of the on-line problems to and the receiving of the answers from the learning device.

The program instructions, when executed by the processor, may further cause the processor to: store, for the student, an average of the problems answered per unit of time from the timing; and further control the timing according to the average.

### BRIEF DESCRIPTION OF THE DRAWINGS

The accompanying drawings, together with the specification, illustrate exemplary embodiments of the present invention. These drawings, together with the description, serve to better explain aspects and principles of the present invention.

FIG. 1 shows an example system of on-line learning by a student according to an embodiment of the present invention.

FIG. 2 shows an example server process for on-line learning according to an embodiment of the present invention.

FIG. 3 shows an example student process for on-line learning according to an embodiment of the present invention.

FIG. 4 illustrates example options for handling electronic allowance earned by a student through on-line learning according to an embodiment of the present invention.

FIG. 5 shows an example parent (or teacher or sponsor) process of on-line learning for a student according to an embodiment of the present invention.

### DETAILED DESCRIPTION

Exemplary embodiments of the present invention will now be described with reference to the accompanying drawings. While the terms “parent,” “teacher,” “sponsor,” and combinations thereof are used throughout the specification to describe the relationship of advocates for a student for some embodiments of the present invention, it is understood that the present invention is not limited to these specific roles. In other embodiments, the terms “parent,” “teacher,” “sponsor,” and combinations thereof refer to any person with an advocative relationship to a student, such as a health professional (e.g., doctor, psychologist), administrator (e.g., principal, guidance counselor), guardian, other relative, etc.

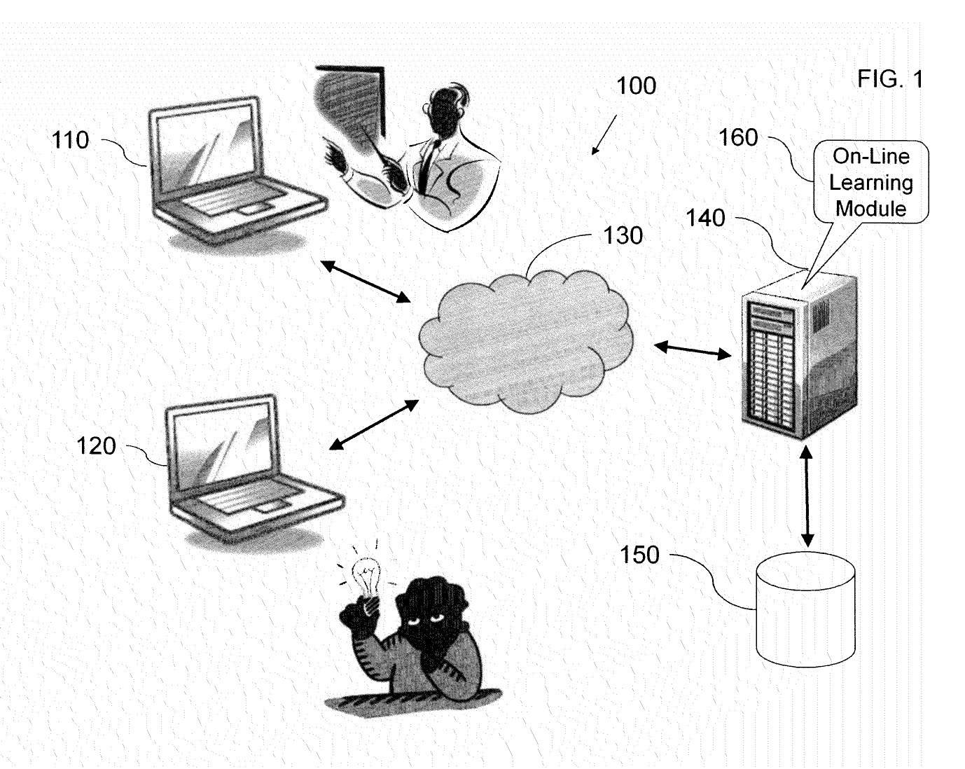

FIG. 1 shows an example system 100 of on-line learning by a student according to an embodiment of the present invention.

The system 100 includes an on-line access device 110 for a parent, teacher, or sponsor of the student, an on-line access device 120 for the student, an electronics communication network 130, a host computing device 140 including a processor, and a non-volatile storage device 150. For ease of description, the term “on-line access device” will be referred to as a “laptop” throughout the specification, but the term is equally applicable to any other wired or wireless device capable of accessing and communicating with the network 130, such as, for example, a computer (e.g., personal computer), a terminal, a laptop (or laptop computer), a tablet (or tablet computer), a personal digital assistant, a smart phone, etc.

The laptop 110 for the parent, teacher, or sponsor (which may be more simply referred to as the parent laptop 110) can be any wired or wireless device capable of communicating with the network 130. There may be multiple laptops 110, for example, one for a parent, one for a teacher, and one for a sponsor of the student. There may also be multiple parents, multiple teachers, or multiple sponsors for the student, each with their own laptop 110. The laptops 110 may also be shared between different persons (such as between two parents). The student also has a laptop 120 for accessing the network 130. The student may also share a laptop 120 with a parent, teacher, or sponsor.

The network 130 can be any network (such as a local area network or wide area network) supporting communication between computing devices. For example, the network 130 can be the Internet.

The host computing device 140 can be any computing device having a processor and memory for executing computer instructions on data. For ease of description, the term “host computing device” will be referred to as a “server” (as in a server computer) throughout the specification, but the term is equally applicable to any other computing device capable of executing computer instructions to access, process, and exchange data over the network 130, such as, for example, a mainframe computer, a minicomputer, a microcomputer, a cloud computer, a blade server, etc. According to one embodiment, the server 140 executes an on-line learning module 160 that manages network access to the on-line learning tools, such as receiving control information from the parent laptop 110 for managing the student's access to the learning tools, delivering course content to and receiving answers from the student's laptop 120, grading the answers, and managing the electronic allowance and funding. For example, the on-line learning module 160 can communicate with parent and student laptops 110 and 120 via web-based graphical user interfaces (GUIs), as would be apparent to one of ordinary skill in the art.

The non-volatile storage device 150 is for storing program instructions and databases for access by the server 140. For ease of description, the term “non-volatile storage device” will be referred to as “disk drive” throughout the specification, but the term is equally applicable to any storage device capable of long-term data storage, such as, for example, a solid-state drive, an optical drive, etc. The program instructions (such as for the on-line learning module 160) are for executing on the processor of the server 140, and cause the server 140 to implement embodiments of the present invention. The databases include, for example, a student database to maintain information about the student (such as access to the on-line learning tools, allowance information, performance information, grades, etc.), a content database for storing problems (and organized by grade level or difficulty, as well as by subject), etc.

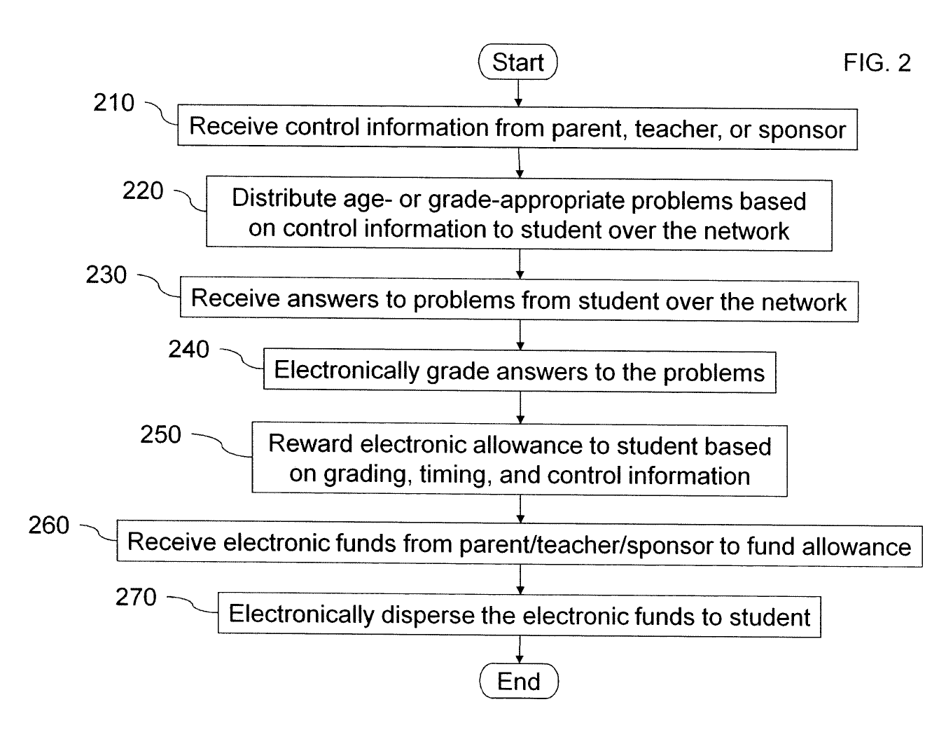

FIG. 2 shows an example server process for on-line learning according to an embodiment of the present invention. This and other processes disclosed in the present application may be described in terms of a software routine implemented, for example, by the on-line learning module 160. A person of skill in the art should recognize, however, that the process may be implemented via hardware, firmware (e.g. via an ASIC) or any combination of software, firmware, and/or hardware. Furthermore, the sequence of steps of the process is not fixed, but can be altered into any desired sequence as recognized by a person of skill in the art.

Processing begins, and in step 210, the on-line learning module 160 receives control information from the parent, teacher, or sponsor laptop 110. In addition to setting up a student account with the on-line learning module 160, the control information may take the form of, for example, content controls (such as age, grade, or difficulty level, or subject), education or graduation benchmarks, rate information for earning an electronic allowance (such as how much per hour, e.g., $3/hour, or for what type of problems), and timing information (such as how fast or for how long to deliver the content).

In step 220, the on-line learning module 160 distributes age- and grade-appropriate problems based on the control information to the student laptop 120 over the network 130. In one embodiment, the problems may include visual and or aural content (including text, speech, pictures, sounds, video, etc.) and solicit multiple choice, single word, or phrase-type answering patterns. In another embodiment, the problems solicit screen manipulation (for example, clicking, dragging and dropping, drawing, etc.). The on-line learning module 160 may deliver these problems by one or more of, for example, a GUI interface with the student laptop 120, or a previously recorded or digitally synthesized voice pattern, or other delivery method that would be apparent to one of ordinary skill in the art. The problems may be delivered, for example, one at a time from the on-line learning module 160, or in groups of problems to be delivered via the student laptop 120 GUI interface.

In step 230, the on-line learning module 160 receives answers to the problems from the student laptop 120 over the network 130. In one embodiment, the student may respond to the problem GUI or voice transmission (or other delivery method) by, for example, typing a response on a keypad or touch screen, using a mouse or other pointer or controller, speaking a response into a voice recognition device (such as a microphone with appropriate software for speech recognition), or other suitable input device as would be apparent to one of ordinary skill in the art. The answers may be received, for example, one at a time by the on-line learning module 160, or in groups of answers that are collected, for example, by the student laptop 120 GUI interface.

In step 240, the on-line learning module 160 electronically grades the answers to the problems. In one embodiment, the problems may have answer patterns that include multiple choice, fill-in-the blank, word choice, phrases, written or spoken, or may be in the form of screen manipulations (clicking, dragging and dropping, drawing). The on-line learning module 160 grades each of these responses electronically according to a set of acceptable answers (such as a predetermined set of answers) and comes up with a performance score for the student on the problem or set of problems. As part of the grading, timing information, such as on a per-problem basis, or on a set of problems, may also be obtained. This can be collected, for example, by the difference in time between when the on-line learning module 160 delivers the problem or problems and when it receives the answers, or it can be collected on the student laptop 120 as part of the problem delivery and answer collection GUI, or the problems can be delivered by the on-line learning module 160 or through the student laptop 120 GUI to require a response within a certain time (such as a predetermined amount of time, as might be set up in the control information).

In step 250, the on-line learning module 160 rewards electronic allowance to the student based on factors such as the grading and/or timing of the answers, and the control information, including factors such as the difficulty of the problem relative to the student's ability, the subject matter, the history of the student's allowance for the problems (e.g., has the student already received allowance for answering the problems), the number of problems correctly or incorrectly answered, the time taken to answer the problems, and the input from the parent, teacher, or sponsor as to what problems or answers qualify for allowance rewarding. The electronic allowance is maintained by the on-line learning module 160 for the student as part of the student's account. In one embodiment, the electronic allowance takes the form of virtual money (such as virtual dollars) that become real money once they are backed by electronic funds (such as by secure credit or debit, or electronic funds transfer through a commercial bank account) by the parent, teacher, or sponsor.

In step 260, the on-line learning module 160 receives electronic funds from parent, teacher, or sponsor to fund the allowance. In one exemplary embodiment, the on-line learning module 160 provides a secure credit or secure debit GUI for electronically transferring the funds from the parent. In another embodiment, the on-line learning module 160 allows for electronic funds transfer from the parent's, teacher's, or sponsor's commercial bank account to the student's electronic funds account maintained by the on-line learning module 160. The parent, teacher, or sponsor may, for example, provide these funds up front, so that they are available to fund the allowance as soon as the allowance is earned by the student, or they may be provided in response to the student earning the allowance, or they may be provided as the parent, teacher, or sponsor has the ability to provide them. In one embodiment, unfunded portions of the allowance are banked by the on-line learning module 160 for later funding (for example, with younger students, or when the funds are not available at the moment). Multiple parents, teachers, or sponsors of the student may take part in the funding process.

In step 270, the on-line learning module 160 electronically disburses the electronic funds to the student. For example, the on-line learning module 160 may present a GUI to the student on the student laptop 120 allowing the student to allocate the disbursed funds to, for example, one of several places. In one exemplary embodiment, the on-line learning module 160 presents three choices for allocating the funds: (1) they can be spent at an on-line retailer (e.g., Amazon, Apple, or iTunes) that is partnered with the on-line learning module 160, (2) they can be left in a savings account (for example, until further funds can be accumulated and then spent), or (3) they can be donated to a church or charitable institution. In one exemplary embodiment, the control information supplied by a parent, teacher, or sponsor controls some or all of how the disbursed funds are allocated.

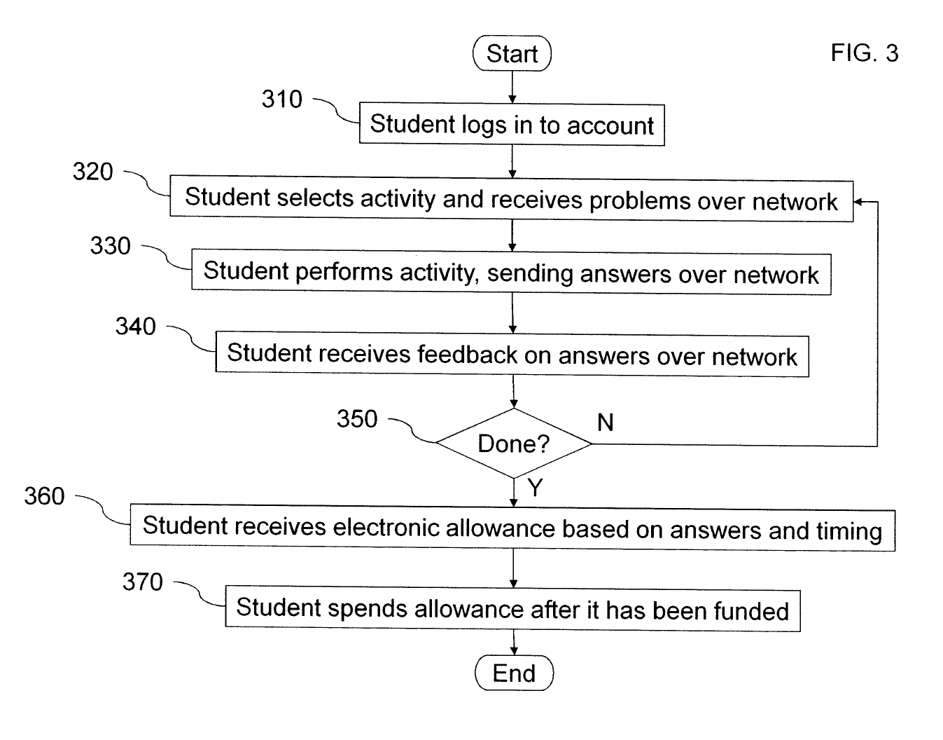

FIG. 3 shows an example student process for on-line learning according to an embodiment of the present invention.

Processing begins, and in step 310, the student logs in to his or her account with the on-line learning module 160 from the student laptop 120. The on-line learning module 160 maintains an account for the student, including information such as, for example, progress to date, electronic allowance earned, electronic funds available for spending, etc. The student may log in, for example, using a user ID and password GUI interface as is known to one of ordinary skill in the art.

In step 320, the student selects an activity and receives problems over the network 130 from the on-line learning module 160. The student may, for example, select a subject area, a difficulty level, a number of problems or amount of time to work, etc., using the student laptop 120, such as through a GUI as would be apparent to one of ordinary skill in the art. In one embodiment, some or all of this selection is done for the student based on control information received by the on-line learning module 160 from the parent, teacher, or sponsor. In response, the on-line learning module 160 delivers the requested content (such as on-line problems) to the student laptop 120.

In step 330, the student performs the activity on the student laptop 120, sending corresponding answers over the network 130 to the on-line learning module 160. See, for example, the description of step 230 in FIG. 2 above.

In step 340, the student receives feedback on the answers in step 320 over the network 130 from the on-line learning module 160. The feedback may take the form of, for example, the number of correct answers, answers to incorrectly answered problems, timing information (e.g., amount of time per problem, ahead of or behind appropriate pace, etc.), or current status of a series of problems still being answered by the student.

In step 350, when a student finishes an activity or otherwise decides to stop an activity, the on-line learning module 160 may inquire if the student is done with the current session, or whether the student would like to pursue the same or a different activity. For example, the on-line learning module may solicit through the student laptop 120 GUI whether the student would like to change subjects, change difficulty levels, continue with the current subject and difficulty level, change the type of format of the problem set, etc. If the student is not finished with the current session, processing may proceed back to step 320, with the student requesting a new activity or continuing the previous activity via the student laptop 120.

In step 360, the student receives electronic allowance from the on-line learning module 160 based on factors such as the grading or timing information for the completed work, whether allowance is available (as might be controlled by the control information supplied by the parent, teacher, or sponsor, or factors such as difficulty of the subject matter or if the completion represents a new achievement by the student versus a repetition of a past achievement). The electronic allowance is maintained by the on-line learning module 160 for the student.

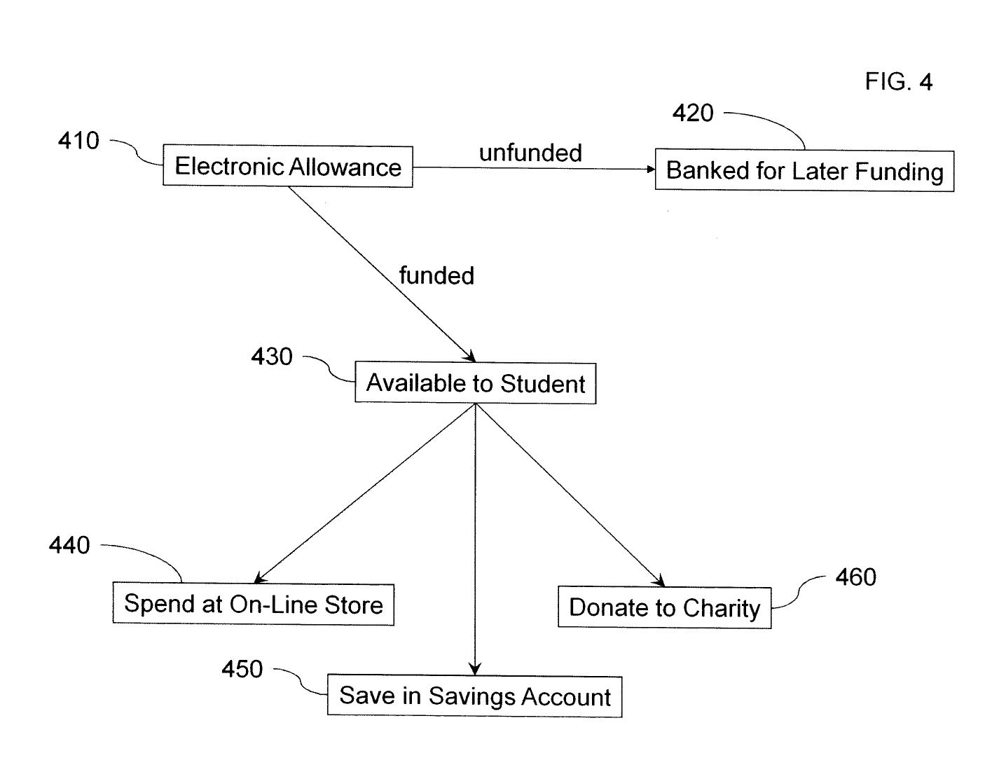

In step 370, the student spends the allowance after it has been funded by a parent, teacher, or sponsor. This may include, for example, on-line shopping, or putting the electronic funds in a savings account, or donating the funds to a church or charitable organization, as described further with reference to FIG. 4. Depending on the control information supplied by the parent, teacher, or student, some or all of the spending decisions or allocations to different areas (e.g., shopping, saving, donating, etc.) may be decided up front before the student gets to choose.

FIG. 4 illustrates example options for handling electronic allowance earned by a student through on-line learning according to an embodiment of the present invention.

In FIG. 4, the electronic allowance 410 is allocated by the on-line learning module 160 to the student for the completion of tasks (e.g., problem sets) as directed by the control information provided by a parent, teacher, or sponsor. At this point, the allowance is virtual. That is, though it can be expressed in a form of currency (e.g., dollars), there is nothing necessarily backing the allowance with real currency. Accordingly, in one embodiment, based on the control information and any funds provided by the parent, teacher, or sponsor, the electronic allowance 410 is divided between two categories: (1) the allowance can be banked 420 for later funding by a parent, teacher, or sponsor (such as with a younger student, or when insufficient resources are available to fund it), or (2), the allowance can be funded 430 by the parent, teacher, or sponsor and made available to the student (for example, money can be electronically transferred to the student's account from the parent, teacher, or sponsor, such as ahead of time or at the earning of the allowance).

In one embodiment, once funded 430, the electronic allowance can be disbursed by the student, such as (i) spent 440 at an on-line store (e.g., Amazon, Apple or iTunes) partnered with the on-line resource module 160 by the student how he or she wishes, or (ii) saved 450 in a savings account (e.g., to be accumulated with further savings to purchase more expensive items from an on-line store), or (iii) donated 460 to a charitable organization or church. This further allows the student an easier way to manage money responsibly. In one embodiment, the parent, teacher, or sponsor can provide control information providing rules or restrictions controlling all or part of the allocation of funds to the different categories (and possibly how it is to be disbursed within each category).

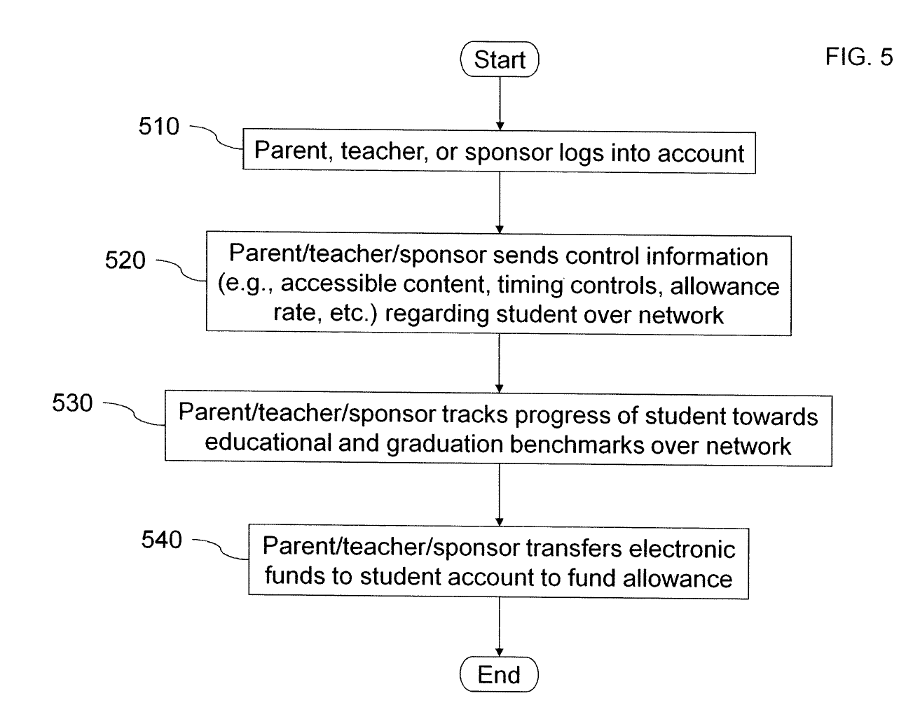

FIG. 5 shows an example parent (or teacher or sponsor) process of on-line learning for a student according to an embodiment of the present invention.

Processing begins, and in step 510, the parent, teacher, or sponsor logs into their account with the on-line learning module 160 from the parent laptop 110. The on-line learning module 160 maintains an account for the parent, teacher, or sponsor (which may be a shared account or multiple accounts for different parents, teachers, or sponsors of the same student), including information such as control information for managing the student's on-line learning as well as electronic funds on deposit for funding the electronic allowance once it is earned by the student. The parent, teacher, or sponsor may log in, for example, using a user ID and password GUI interface from the parent laptop 110 as is known to one of ordinary skill in the art.

In step 520, the parent, teacher, or sponsor sends control information (e.g., accessible content, timing controls, allowance rate, etc.) regarding the student over network 130 from the parent laptop 110. This is similar to step 210 of FIG. 2, whose above description is not repeated here.

In step 530, the parent, teacher, or sponsor tracks the progress of the student towards educational and graduation benchmarks over the network. For example, the parent, teacher, or sponsor may see what problem sets have been completed, including their grading and timing information. The parent, teacher, or sponsor can also assess the student's progress towards certain goals, such as grade-level goals or graduation goals. The parent, teacher, or sponsor can also see how much electronic allowance has been accrued by the student, but not been funded. In one embodiment, the parent can also analyze the spending behavior of the student's allowance after it has been funded. This allows the parent, teacher, or sponsor to take a more active role in the on-line learning process.

In step 540, the parent, teacher, or sponsor transfers electronic funds to the student account to fund the electronic allowance. This can take place, for example, before or after the student has earned the allowance. For example, the electronic funds may go out as a monthly transfer on the parent's credit, debit, or checking account. Those funds that arrive when the student did not have an electronic allowance balance would sit until the student earned the allowance, at which point the allowance could be immediately funded.

### Exemplary Embodiment

What follows is a series of highlights and features of an exemplary embodiment of the present invention. Representative screen shots from the embodiment are illustrated and described in FIGS. 1-15 of the Provisional Application.

Default settings: For purposes of example the earn rate is set at 85, 3, 5. (85% correct (25 of 30), clocked at 6 seconds per cluster (Fast) or 3 seconds per cluster (Faster), earns $5 per hour of play).

The visual association of words, vocabulary, and the adrenaline rush produced by the clocked play is a kind of rope jumping for the brain and “trains the brain” to think sharply and with focus.

| Game Terms | and | Features |
|---|---|---|
| Advanced Player Feature | Sprint | Reverse Sprint |
| (APF) | Lap | Chuckle Clusters |
| Categories | Directed Shuffle | Visual Clusters |
| Clocking and . . . | Random Shuffle | Audio Clusters |
| . . . Hit & Miss %, | Marathon | Compete Options |
| Earn Rate | Cascading Category | Hyper Clocking |
| Cluster | | Mobile Play |

While all features are customizable by the parent, teacher, or sponsor of the student, the following 4 components of the embodiment are primary and defined below.

| | | | |
|---|---|---|---|
| Categories | Clocking | Earn Rate | Spend, Save |
| | the | | Bank or |
| | Hit & Miss | | Donate |
| | Categories % | | |

Game features designated as Advanced Player Features are noted as (APF)'s.

Categories . . . as in a smorgasbord of . . . and custom written . . . from the factual to the funky and fun and from the academic to the arcane categories that combine academic seriousness with funky frivolity. Categories in all school grade levels and all school subjects along with countless splinter categories that cascade off the primary subject (see Cascading Categories) as well as fun, unexpected categories such as movie, music & sports trivia, crime, Un-Pop culture . . . on and on . . . .

. . . Language sub-categories such as Slang that include Finish the Yiddish, Southern, Urban, Valley Girl, Surfer, Spanglish & Queenglish . . . on and on . . . .

. . . Fact, Fiction or Opinion categories, art, religion, astronomy, architecture, fashion to hundreds of as-yet undeveloped categories. Whether factual or frivolous—the student is engaged in improving their vocabulary, word association & reading skills and earning their “academic allowance” while doing so.

### Clocking the Hit & Miss % (see Hyper Clocking APF)

All categories are clocked and keep a % of correct answers in the game box (for current play) as well as in the player profile (for historical play). Keeping in mind that a parent or teacher best knows the student they sponsor, we emphasize that the clocking and earn rate are adjustable at the discretion of the sponsor. However, in the embodiment, all categories have a default clocked setting until customized by the sponsor.

### Earn Rate

Children's “academic allowance” is funded by a parent, teacher, or sponsor, who also set the performance and earn rate. Spend, Save, Bank or Donate or options are part of the Parent Child Account Profile. Secure online credit & debit options will be available to fund the annual subscription as well as the child's earnings. Within the Parent Child Account Profile, all parameters for the student's use will be coded and adjustable by the parent, teacher, or sponsor.

Parents select the categories they want to assign earn rates to and can pre-set the clock depending on the difficulty level. Parents may also elect to not provide earnings for categories that are less academically rigorous but may be fun and frivolous. They may also elect not to fund earnings for younger children. The player sees their earnings tabulate instantly as they play and at the completion of every sprint, lap, or marathon (i.e., length of a continuous session of answering problems).

Allocating your Child's Earnings

Parents/sponsors may assign a higher “academic allowance” for successfully running laps or marathons versus simply completing sprints. They may also offer enhanced earnings for students who engage in APF's like cascading categories or reverse sprints.

They may also assign higher earnings for students who self-challenge by playing grade levels above their own. We emphasize that categories played, clocking, earn rate, and compete features are all customizable at the discretion of the parent. Thus, funded earnings are available immediately for the child to Spend, Save, Bank, or Donate.

Given the lessons parents may want to impart to their children about the value of earning, saving, thrift, responsible spending, and donating to their church or favorite charity, we again emphasize that all parameters are customizable at the discretion of the parent, including the allocation of their child's earnings. For example, with the average weekly allowance for kids between the ages of 10-17 being $13.96×52 weeks in a year ($726), a parent might choose to allocate 50% for Spending and 50% for Donating, or as in the example below simply earmark 25% for each option.

| Spend 25% | Save 25% | Bank 25% | Donate 25% |
|---|---|---|---|
| . . . immediately | . . . short | . . . long-term | to favorite |
| with online partners | term . . . | saving for future | charity or |
| such as Amazon, | toward | matching or online | church |
| Apple, etc. | purchase goals | savings goals | |

Allocation of the child's earnings will be easily customized by the parent or sponsor in the Parent Child Account Profile.

### Spend, Save, Bank or Donate Options

Keep in mind that a student's earnings are immediate when they achieve performance levels set by their parent, teacher, or sponsor. However, the funds are only available to be spent by the student if their account is funded by their sponsor.

Spend: If a student's earnings are funded, it is available for immediate spending. On which sites they may spend their allowance is pre-set in the Parent Child Account Profile. For example, a child funded at an earn rate of $3 per hour having successfully completed 2 hours of play can then instantly download songs, buy books, or otherwise spend their allowance as pre-approved in their profile and on pre-approved partner sites.

Save: If a student's earnings are funded, it is available for immediate spending but they may choose to Save their allowance for the short term. Over a period of weeks or even months they may choose to Save their earnings toward purchases goals such as iPads, iPhones, computers, cameras, clothing, school supplies, and books.

Strategic retail partnerships: (See additional notes on Strategic Partners).

The menu of online purchase options will be offered through the numerous sites with which the embodiment of the present invention collaborates, and as always will be pre-set by the parent, teacher, or sponsor in the Parent Child Account Profile.

Bank: Whether a student is funded or unfunded, this option allows a student to Bank their earnings for future matching and still experience the immediate thrill of earning for their learning until the parent is willing or able to fund the child's earnings.

There may be myriad reasons a parent & child choose to Bank their earnings. Whether the child is too young for an “academic allowance”, lean financial times in the household, or the parent chooses to incentivize their child's earnings and potential matching in other ways, the Spend, Save or Bank options allow parents to personalize the Learn & Earn experience on the embodiment to best suit their individual goals.

Donate: Parents/sponsors and their child may choose to allocate all or any portion of their earnings to a qualified non-profit organization or their church as pre-approved in their profile.

Online options for donating gifts to the charity of their choice will be available in a single-hop on the embodiment.

A Cluster is 1 clue and 3 potential answers. Clusters and the Sprints, Laps, and Marathons they make up will be data-deep such that a user will rarely encounter the same rotation of clusters twice, keeping the learning exercise engaging, fresh and challenging. Keep in mind that as a student views each cluster on the on-line interface of the embodiment, the clock is counting down.

See (5) sample categories and clusters below.

(1) School Subjects, English; Oxymorons

| | |
|---|---|
| Oxymorons | Sharp knife |
| | Good grief |
| | Slippery ice |

(2) Languages; Slang; Finish the Yiddish

| | |
|---|---|
| Rabbi | Meatball soup |
| | Millions of rabbits |
| | A learned person |

(3) English literature; Novels; Famous First Lines

| | |
|---|---|
| Moby Dick | Who is John Galt? |
| | Call me Ishmael |
| | A screaming comes across the sky |

(4) US Geography; Where am I?

| | |
|---|---|
| Liberty Bell | Boston |
| | Chicago |
| | Philadelphia |

(5) School Subjects, English; Synonyms

| | |
|---|---|
| Stubborn | Angry |
| | Sticky |
| | Persistent |

A Sprint is 30 consecutive clusters in a given category and the minimum length of any game in any category. Sprints can be run individually or as laps or marathons. Along with Reverse Sprints, Laps & Marathons are APF's for self-challenging, ambitious students. An abbreviated 3-cluster sprint sample in State Capitals is provided below.

| | | |
|---|---|---|
| State Capitals | New Mexico | Sacramento |
| | | Santa Fe |
| | | Tucson |
| | Texas | Lubbock |
| | | Dallas |
| | | Austin |
| | Arkansas | Memphis |
| | | Little Rock |
| | | Nashville |

A Lap consists of running 5 sprints consecutively without break, or 150 clusters. Laps can be run as directed or random shuffles.

Running 1 lap clocked at 5 seconds per cluster would be 13 minutes of adrenaline charged, mind-focused brain training.

Directed shuffles pull 5 sprints from any general category chosen by the player such as 6th grade grammar or any specific sub-category such as 6th grade grammar adjectives.

Random shuffles pull 5 sprints randomly from all categories and sub-categories in that player's grade level. Here again, the embodiment enables a parent to challenge, incentivize & reward their child by customizing their profile to provide additional “academic allowance” if their child performs well in subjects or grade levels above their own.

A Marathon includes running 3 laps consecutively without break, or 450 clusters.

Running 1 marathon at 4 seconds per cluster would be 30 minutes of hyper focused, hurdle jumping for the brain.

| It is worth . . . | Performing . . . | A vital slice . . . |
|---|---|---|
| . . . emphasizing that some (APF's) | . . . well in the less rigorous Sprints | . . . of the initial subscribers we will |
| such as Marathons, Cascading | and Laps trains the brain to be | court are ambitious students who |
| Categories, and Hyper Clocking may | nimble, sharp and focused. | compete in academic decathlons & |
| strain the brain and be out of reach | Stretching the mind for the | other competitions. |
| for some students... | eventuality of running these APF's | The APF's of the embodiment are for |
| | successfully is part of the reach we | all players, but will have special |
| | hope to inspire students to make. | appeal to these students. |

A Cascading Category is comprised of a primary category splintering into innumerable, interrelated sub-categories. Cascading categories rigorously expand & test the subject knowledge of the student, albeit at times in the direction of trivia—but always improving reading, vocabulary, and word association skills. The content in a cascading category is presented in the same way, i.e.: via Cluster-Sprints (1 Clue, 3 potential answers).

All school subjects, indeed all subjects school or not have the potential to provide cascading categories. The ability to successfully “cascade a category” means the student has studied and knows that category in-depth—frontwards, backwards, sideways, upside down and inside-out.

Consider below a cascading category that splinters off from the subject US Geography, States:

### Cascading Category Sample in US Geography, States

| | |
|---|---|
| States | . . . Capital city |
| by . . . | . . . population |
| | . . .abbreviation |
| | . . . flag |
| | . . . landmark |
| | . . . cities |
| | . . . rivers |
| | . . . size (landmass) |
| | . . . industry |
| | . . . bird |
| | . . . motto |
| | . . . flower |
| | . . . nickname |
| | . . . date of statehood |
| | . . . University or college |
| | . . . celebrity |
| | . . . historical event (cross category with History) |
| Cities | . . . sports team |
| by . . . | . . . stadium |
| | . . . landmark |
| | . . . museum |
| | . . . population |
| | . . . historical event |

Reverse Sprint: Similar to a student “cascading a category,” running Reverse Sprints is an advanced feature that enables the student to pluck facts & knowledge from their own wherewithal. Opposite of cluster-sprints that provide 1 clue and 3 multiple choice answers, Reverse Sprints provide 3 clues, 1 answer—and require the student to type the answer in the field, also while the clock counts down. See sample below.

### Category: United States Geography/States

| | |
|---|---|
| Peanuts, pecans & peaches | State? |
| 13th colony | |
| The Color Purple | |

To break the adrenaline rush of running the clocked sprints and to add the occasional chuckle to the effort, Chuckle Clusters will be sprinkled throughout all categories. Chuckle clusters might appear randomly in a “sprint” of 30, such as in the 2 category examples below.

### Sample Chuckle Clusters

| | Finish the Phrase |
|---|---|
| First in History? | Clue: People who live in glass houses |
| Albert Einstein | should always wear robes |
| Louis Pasteur | |
| Isaac Newton | |
| ↓ | ↓ |
| Bart Simpson | shouldn't throw stones |
| Bugs Bunny | |
| Beavis | |
| ↓ | ↓ |
| Harriet Beecher Stowe | buy lots of Windex |
| Eleanor Roosevelt | |
| Hilary Clinton | |

Visual clusters (To provide the millions of visual & audio clues needed for this feature, see Strategic Retail Partnerships).

See visual sample below that might be tailored to higher-grade art history students. The list of visual categories that will be developed is vast—every conceivable subject may cascade into multitudes of varied categories.

| | | | |
|---|---|---|---|
| Category | Art History | Clue . . . | . . . Edgar Degas |

Or just for fun, consider a visual cluster a student in High School AP Chemistry will ponder:

| | | |
|---|---|---|
| Category | Clue . . . | . . . Polyatomic Ion |

### Audio Clusters

The same potential exists for limitless audio categories. Again, from the academic, such as snippets of historical speeches where the player identifies the speaker to the fun & frivolous such as identifying sound bites from birdsongs, rock songs, musical instruments, dialogue from movies, plays & musicals, animal sounds, movie & TV theme songs, etc. on & on . . . .

### Compete Options

Whether one-on-one, (child vs. child, child vs. parent), self-challenges or group competitions such as teacher led classroom or school vs. school contests, the compete feature will enable players to compete near & far, with players known & unknown. Whether running Sprints, Laps, Marathons, Cascades, or Reverse Sprints, the embodiment is coded to pitch the same information in the same sequence to all players. Parent/sponsors may provide enhanced earnings for prevailing. Remember, categories played, clocking, earn rate and compete features are all customizable at the discretion of the parent.

Teachers may customize their own in-class rewards for those who prevail in competitions.

### Hyper Clocking

Truly a feature for students who relish challenging themselves. Hyper Clocking averages the response time for all clusters answered in a chosen category then re-calibrates the clocking speed to 1/10 of a second less than that average. Thus if a student's average response time in a given category is 2.7 seconds per Cluster, the Custom Clocking feature will run them at 2.6 seconds per cluster. When the student's response time continues to improve, Hyper Clocking will continue to re-calibrate—if this feature is chosen by the sponsor or student.

### Mobile Play

Long, summer vacation drive to Yosemite National Park—kids in the backseat—spend some time playing the embodiment on their IPod—Learn & Earn some allowance—then Spend that allowance, immediately downloading songs to their IPod, or making other online purchases at sponsor-approved sites. Of course, they may also Save, Bank, or Donate their “academic allowance,” but the beneficial result is achieved—Kids learning—earning—focused & occupied. Whatever the mobile device—wherever the locale—the embodiment is mobile accessible by all major applications.

### Word Strings

Strings are more complex, subject-driven exercises than are Clusters and can be used by the student repeatedly for optimum retention of subject material. An example String is for The Declaration of Independence. Strings lead the learning of facts chronologically, one fact or concept following another so the subject material is learned organically and trained into the brain for optimal retention.

Strings being much more data & subject intensive will be a secondary stage development.

### GradLock

### GradLock is a Secondary Stage Endeavor to the Embodiment . . . .

. . . and will be a monetary incentive & vesting feature payable to those who achieve high school graduation.

Given that high school students living in low-income families drop out of school at six times the rate of their peers from high-income families, (all4ed.org/ (U.S. Department of Education, National Center for Education Statistics, 2004)), GradLock is structured to incentivize low-income students to work for, plan and attain their high school diploma.

GradLock is a cousin to the Learn & Earn component offered through the embodiment.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An automated method of on-line learning for a student over an electronic communications network, comprising:
electronically receiving, over the network, control information related to the student from one or more parents, teachers, or sponsors of the student;
electronically distributing, over the network, on-line problems from a content database arranged by levels of difficulty and by categories to an electronic learning device of the student based on the control information;
electronically receiving, over the network, answers to the problems from the learning device;
electronically grading the answers to the problems; and
rewarding an electronic allowance to the student based on the grading of the answers and the control information.

2. The method of claim 1, wherein the control information comprises one or more of:
one of the levels of difficulty;
one of the categories;
educational or graduation benchmarks;
a rate of earning the allowance; or
timing between the distributing of the on-line problems and the receiving of the answers to the problems.

3. The method of claim 2 further comprising distributing, to the one or more parents, teachers, or sponsors, tracking or verification information of the student related to the educational or graduation benchmarks.

4. The method of claim 1 further comprising receiving, from the one or more parents, teachers, or sponsors, electronic funds to fund the allowance.

5. The method of claim 4 further comprising disbursing the electronic funds to the student based on the allowance and the control information.

6. The method of claim 5, wherein the disbursing of the electronic funds comprises one or more of on-line shopping at a retail enterprise, on-line savings to a savings account, or on-line donations to a charitable institution.

7. The method of claim 4 further comprising electronically banking an unfunded portion of the allowance for later funding.

8. The method of claim 1, wherein the learning device comprises a computer, a laptop, a tablet, a personal digital assistant, or a smart phone.

9. The method of claim 1 further comprising controlling a timing of the distributing of the on-line problems to and the receiving of the answers from the learning device.

10. The method of claim 9 further comprising:
electronically storing, for the student, an average of the problems answered per unit of time from the timing; and
further controlling the timing according to the average.

11. A system of on-line learning for a student, comprising:
a processor coupled to an electronic communications network; and
a non-volatile storage device coupled to the processor and storing:
a content database comprising problems arranged by levels of difficulty and by categories; and
program instructions,
wherein the program instructions, when executed by the processor, cause the processor to:
receive, over the network, control information related to the student from one or more parents, teachers, or sponsors of the student;
distribute, over the network, on-line problems from a content database arranged by levels of difficulty and by categories to an electronic learning device of the student based on the control information;
receive, over the network, answers to the problems from the learning device;
grade the answers to the problems; and
reward an electronic allowance to the student based on the grading of the answers and the control information.

12. The system of claim 11, wherein the control information comprises one or more of:
one of the levels of difficulty;
one of the categories;
educational or graduation benchmarks;
a rate of earning the allowance; or
timing between the distributing of the on-line problems and the receiving of the answers to the problems.

13. The system of claim 12, wherein the program instructions, when executed by the processor, further cause the processor to distribute, to the one or more parents, teachers, or sponsors, tracking or verification information of the student related to the educational or graduation benchmarks.

14. The system of claim 11, wherein the program instructions, when executed by the processor, further cause the processor to receive, from the one or more parents, teachers, or sponsors, electronic funds to fund the allowance.

15. The system of claim 14, wherein the program instructions, when executed by the processor, further cause the processor to disburse the electronic funds to the student based on the allowance and the control information.

16. The system of claim 15, wherein the disbursing of the electronic funds comprises one or more of on-line shopping at a retail enterprise, on-line savings to a savings account, or on-line donations to a charitable institution.

17. The system of claim 14, wherein the program instructions, when executed by the processor, further cause the processor to bank an unfunded portion of the allowance for later funding.

18. The system of claim 11, wherein the learning device comprises a computer, a laptop, a tablet, a personal digital assistant, or a smart phone.

19. The system of claim 11, wherein the program instructions, when executed by the processor, further cause the processor to control a timing of the distributing of the on-line problems to and the receiving of the answers from the learning device.

20. The system of claim 19, wherein the program instructions, when executed by the processor, further cause the processor to:
store, for the student, an average of the problems answered per unit of time from the timing; and
further control the timing according to the average.
